(19) United States
(12) Patent Application Publication
(10) Pub. No.: US 2026/0067311 A1
(43) Pub. Date: Mar. 5, 2026

(54) SECURITY AUDIT APPARATUS, SECURITY AUDIT METHOD, AND NON-TRANSITORY COMPUTER-READABLE STORAGE MEDIUM

(71) Applicant: NEC Corporation, Tokyo (JP)

(72) Inventors: Miho IKEMATSU, Tokyo (JP); Taiga TOMIOKA, Tokyo (JP)

(73) Assignee: NEC Corporation, Tokyo (JP)

(21) Appl. No.: 19/304,882

(22) Filed: Aug. 20, 2025

(30) Foreign Application Priority Data
Aug. 28, 2024 (JP) 2024-146671

(51) Int. Cl. H04L 9/40; G06F 40/279

(52) U.S. Cl. CPC H04L 63/1425; G06F 40/279

(57) ABSTRACT

A security audit apparatus acquires answer information indicating an answer by a target entity to a question regarding implementation of a security countermeasure, and generates audit result information indicating a result of an audit on the implementation of the security countermeasure by the target entity by inputting a prompt for instructing to perform an audit on the implementation of the security countermeasure based on the answer information and the answer information into a language model.

### INCORPORATION BY REFERENCE

This application is based upon and claims the benefit of priority from Japanese patent application No. 2024-146671, filed on Aug. 28, 2024, the disclosure of which is incorporated herein in its entirety by reference.

### TECHNICAL FIELD

The present disclosure relates to a security audit apparatus, a security audit method, and a non-transitory computer-readable medium.

### BACKGROUND ART

A system that facilitates evaluation (that is, security audit) of security countermeasures implemented by companies and the like has been developed. For example, JP 2018-088039 A discloses a system that aggregates information of an audit result created by an auditor using standard item information related to a standard.

### SUMMARY

In JP 2018-088039 A, the security audit is performed manually. The present disclosure has been made in view of this problem, and an example object of the present disclosure is to provide a technique for facilitating an audit regarding security.

A security audit apparatus according to an example aspect of the present disclosure includes an acquisition means for acquiring answer information indicating an answer by a target entity to a question regarding implementation of a security countermeasure, and a generation means for generating audit result information indicating a result of an audit on the implementation of the security countermeasure by the target entity by inputting a prompt for instructing to perform an audit on the implementation of the security countermeasure based on the answer information and the answer information into a language model.

A security audit method according to an example aspect of the present disclosure, executed by one or more computers, includes acquiring answer information indicating an answer by a target entity to a question regarding implementation of a security countermeasure, and generating audit result information indicating a result of an audit on the implementation of the security countermeasure by the target entity by inputting a prompt for instructing to perform an audit on the implementation of the security countermeasure based on the answer information and the answer information into a language model.

A non-transitory computer-readable medium according to an example aspect of the present disclosure causes one or more computers to execute acquiring answer information indicating an answer by a target entity to a question regarding implementation of a security countermeasure, and generating audit result information indicating a result of an audit on the implementation of the security countermeasure by the target entity by inputting a prompt for instructing to perform an audit on the implementation of the security countermeasure based on the answer information and the answer information into a language model.

According to the present disclosure, a technology for facilitating an audit regarding security is provided.

### BRIEF DESCRIPTION OF DRAWINGS

FIG. 1 is a diagram illustrating an outline of an operation of a security audit apparatus;

FIG. 2 is a block diagram illustrating a functional configuration of the security audit apparatus;

FIG. 3 is a block diagram illustrating a hardware configuration of a computer that implements the security audit apparatus;

FIG. 4 is a flowchart illustrating a flow of processing executed by the security audit apparatus;

FIG. 5 is a diagram illustrating a configuration of answer information;

FIG. 6 is a diagram illustrating template information; and

FIG. 7 is a second diagram illustrating the template information.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. Unless otherwise described, predetermined values such as predetermined values or threshold values are stored in advance in a storage device or the like accessible from a device using the values. Furthermore, unless otherwise described, the storage unit includes one or more storage devices of any number.

### Overview

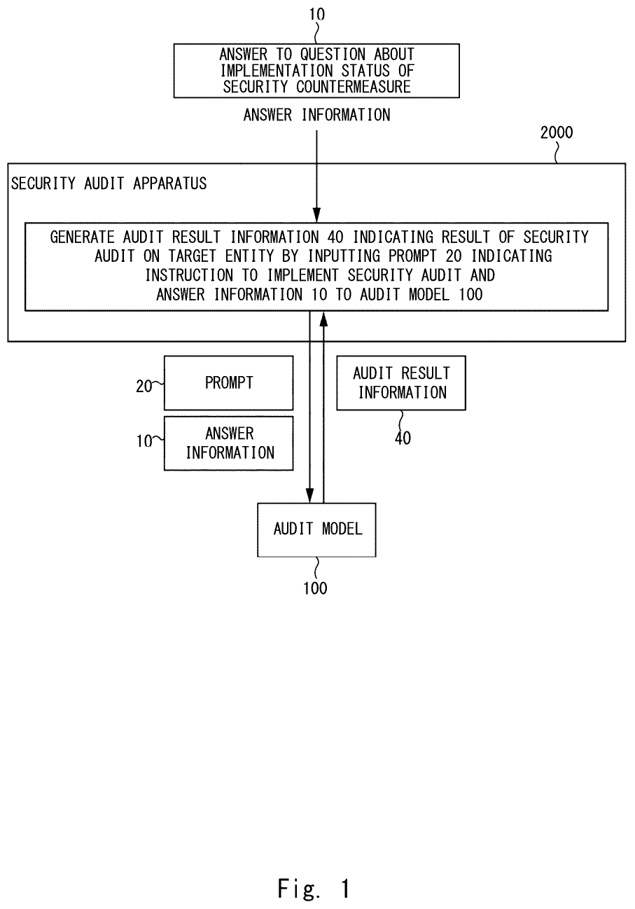

FIG. 1 is a diagram illustrating an outline of an operation of a security audit apparatus 2000. Here, FIG. 1 is a diagram for facilitating understanding of the outline of the security audit apparatus 2000, and the operation of the security audit apparatus 2000 is not limited to the operation illustrated in FIG. 1.

The security audit apparatus 2000 performs a security audit on an entity (hereinafter, target entity) as a target of the security audit. The security here means various types of security such as information security and cyber security. The security audit is performed based on answers obtained from the target entity to questions regarding implementation of security countermeasures.

The target entity is an arbitrary entity that implements security countermeasures. For example, the target entity is one company, one department, one team, one employee, or the like. In addition, for example, the target entity may be a group including a plurality of companies, a plurality of departments, or a plurality of teams.

The security countermeasure means a countermeasure implemented to protect information and system safety. Security countermeasures may be classified into a plurality of categories. The category of the security countermeasure includes, for example, security governance, information management, defense against security threats, detection, coping, and recovery of security threat, and training of human resources dealing with security. The handling referred to herein means handling of a sensed threat. Recovery referred to herein means recovery performed after a threat is addressed.

The security audit means an activity for evaluating whether security countermeasures are properly implemented. For example, the security audit includes identification of insufficiently implemented security countermeasures, suggestion of recommended improvement countermeasures, and the like.

The question regarding the security countermeasure is a question asking the implementation status of the security countermeasure. The answer to the question regarding the security countermeasure indicates the implementation status of the security countermeasure by the target entity.

The implementation status of the security countermeasure is represented by, for example, whether the security countermeasure is implemented, a completeness of the security countermeasure being implemented, or a specific implementation content of the security countermeasure. The completeness of the security countermeasure is represented by a rank such as “1: sufficiently implemented”, “2: implemented to some extent”, “3: not implemented much”, or “4: not implemented at all”.

The security audit apparatus 2000 performs the security audit using an audit model 100. The audit model 100 is a language model composed of an arbitrary machine learning model such as a neural network. The audit model 100 is trained in advance to perform processing based on an instruction and output output data indicating a result of the processing in response to an input of a prompt indicating the instruction.

The security audit apparatus 2000 operates as follows, for example. The security audit apparatus 2000 acquires answer information 10. The answer information 10 indicates an answer by the target entity for each of one or more questions regarding security countermeasures.

The security audit apparatus 2000 uses the audit model 100 to generate audit result information 40 indicating a result of the security audit on the target entity. For example, the security audit apparatus 2000 inputs the answer information 10 and a prompt 20 indicating an instruction to implement the security audit into the audit model 100. In response to the input of the answer information 10 and the prompt 20, the audit model 100 executes the security audit on the target entity based on the content of the answer information 10. Then, the audit model 100 outputs the audit result information 40 indicating an execution result (in other words, the result of the evaluation on the security countermeasure by the target entity) of the security audit. As a result, the security audit apparatus 2000 generates the audit result information 40.

Here, the audit model 100 may operate inside the security audit apparatus 2000 or may operate outside the security audit apparatus 2000. In the latter case, the audit model 100 operates inside another device (hereinafter, a model execution device) other than the security audit apparatus 2000. The expression “the security audit apparatus 2000 generates the audit result information 40” includes not only a mode that “the security audit apparatus 2000 generates the audit result information 40 internally” but also a mode that “the security audit apparatus 2000 causes the audit model 100 operating inside the model execution device to generate the audit result information 40 and acquires the generated audit result information 40”.

### <Example of Operation and Effect>

According to the security audit apparatus 2000, the security audit is executed by the language model by using an answer to a question regarding implementation of the security countermeasure and a prompt for causing the language model to execute the security audit. Therefore, it is possible to reduce labor required for the security audit and time required for the security audit as compared with a case where the security audit needs to be manually performed.

In a case where the security audit is performed manually, it is difficult to completely exclude the subjectivity of the auditor from being included in the security audit, and thus, there is a possibility that the audit result varies depending on each auditor. On the other hand, according to the security audit apparatus 2000, since the security audit is performed using the audit model 100, it is possible to prevent the occurrence of variations in the audit results.

Hereinafter, the security audit apparatus 2000 according to the present example embodiment will be described in more detail.

### <Example of Functional Configuration>

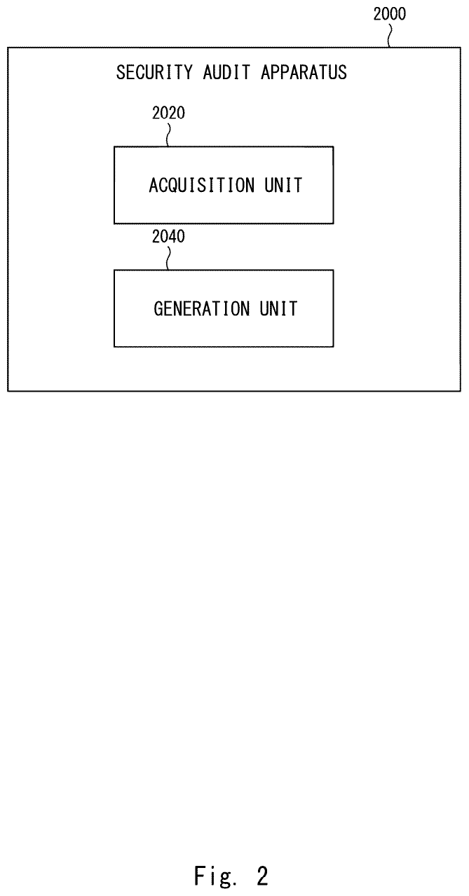

FIG. 2 is a block diagram illustrating a functional configuration of the security audit apparatus 2000. For example, the security audit apparatus 2000 includes an acquisition unit 2020 and a generation unit 2040. The acquisition unit 2020 acquires the answer information 10. The generation unit 2040 generates the audit result information 40 by inputting the answer information 10 and the prompt 20 into the audit model 100.

### <Example of Hardware Configuration>

Each functional unit of the security audit apparatus 2000 may be implemented by hardware that implements each functional component (for example, a hard-wired electronic circuit) or may be implemented by a combination of hardware and software (for example, a combination of an electronic circuit and a program that controls the electronic circuit or the like). Hereinafter, a case where the functional units of the security audit apparatus 2000 are achieved by a combination of hardware and software will be further described.

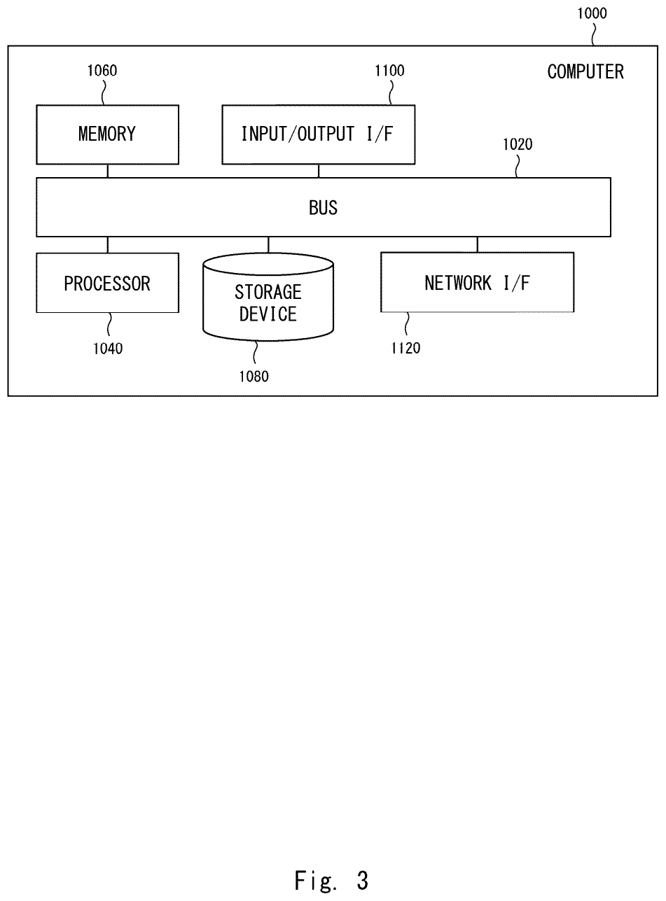

FIG. 3 is a block diagram illustrating a hardware configuration of a computer 1000 that implements the security audit apparatus 2000. The computer 1000 is any computer. For example, the computer 1000 is a stationary computer such as a personal computer (PC) or a server machine. In another example, the computer 1000 is a portable computer such as a smartphone or a tablet terminal. The computer 1000 may be a dedicated computer designed to implement the security audit apparatus 2000 or may be a general-purpose computer.

For example, by installing a predetermined application with respect to the computer 1000, each function of the security audit apparatus 2000 is implemented by the computer 1000. The above-described application is configured with a program for implementing the functional units of the security audit apparatus 2000. The method of acquiring the program is arbitrary. For example, the program can be acquired from a storage medium (Digital Versatile Disc (DVD), Universal Serial Bus (USB) memory, and the like) in which the program is stored. In addition, for example, the program can be acquired by downloading the program from a server device that manages a storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is various processors such as a central processing unit (CPU), a graphics processing unit (GPU), a digital signal processor (DSP), or a field-programmable gate array (FPGA). The memory 1060 is a main storage device achieved using a random access memory (RAM) or the like. The storage device 1080 is an auxiliary storage device implemented using a hard disk, a solid state drive (SSD), a memory card, a read only memory (ROM), or the like.

The input/output interface 1100 is an interface connecting the computer 1000 with an input/output device. For example, an input device such as a keyboard and an output device such as a display device are connected to the input/output interface 1100.

The network interface 1120 is an interface connecting the computer 1000 to a network. The network may be a local area network (LAN) or a wide area network (WAN).

The storage device 1080 stores a program (a program for implementing the above-described application) for implementing each functional unit of the security audit apparatus 2000. The processor 1040 reads the program into the memory 1060 and executes the read program to implement each functional unit of the security audit apparatus 2000. In a case where the audit model 100 is achieved inside the security audit apparatus 2000, a program for achieving the audit model 100 is also stored in the storage device 1080.

The security audit apparatus 2000 may be implemented by one computer 1000 or may be implemented by the plurality of computers 1000. In the latter case, the configurations of the computers 1000 do not need to be the same, and can be different from each other.

### <Flow of Processing>

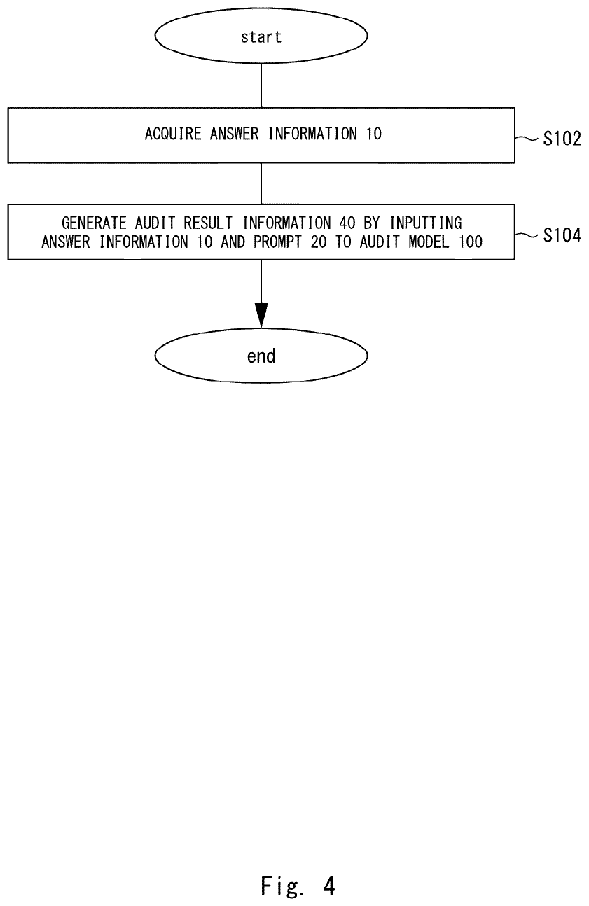

FIG. 4 is a flowchart illustrating a flow of processing executed by the security audit apparatus 2000. The acquisition unit 2020 acquires the answer information 10 (S102). The generation unit 2040 generates the audit result information 40 by inputting the answer information 10 and the prompt 20 into the audit model 100 (S104).

### <Acquisition of Answer Information 10: S102>

The acquisition unit 2020 acquires the answer information 10 (S102). There are various methods for the acquisition unit 2020 to acquire the answer information 10. For example, the answer information 10 is stored in advance in an arbitrary storage unit in a mode accessible from the security audit apparatus 2000. In this case, the acquisition unit 2020 acquires the answer information 10 by reading the answer information 10 from the storage unit. The answer information 10 to be read from the storage unit is designated by the user of the security audit apparatus 2000, for example.

In addition, for example, the answer information 10 may be transmitted from another device to the security audit apparatus 2000. In this case, the acquisition unit 2020 acquires the answer information 10 by receiving the answer information 10 transmitted from another device.

For example, it is assumed that the security audit apparatus 2000 is available via a web system. In this case, for example, the user of the security audit apparatus 2000 accesses a web system from a user terminal (a PC, a smartphone, or the like), and provides the answer information 10 to the security audit apparatus 2000 via the web system.

### <Contents of Answer Information 10>

The answer information 10 indicates an answer to each of one or more questions regarding the implementation status of the security countermeasure. For example, the answer information 10 indicates, for each of one or more questions regarding the implementation status of the security countermeasure, a text indicating the question and a text indicating an answer to the question in association with each other.

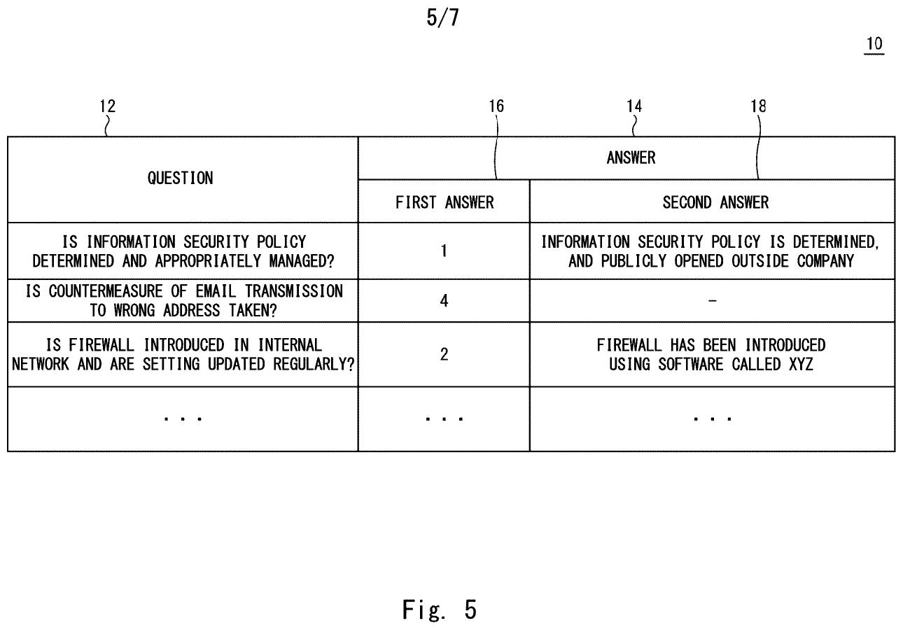

FIG. 5 is a diagram illustrating a configuration of the answer information 10. The answer information 10 indicates a record in which a question 12 and an answer 14 are associated with each other for each of the plurality of questions. The question 12 indicates text indicating the question. For example, a question S1 related to the security countermeasure is a question such as “Is S1 being implemented?”. As a more specific example, the question 12 of the first record in FIG. 5 indicates a question regarding the implementation status of the security countermeasure of “Establish and appropriately manage information security policy”.

The answer 14 indicates an answer to the corresponding question. The answer 14 may include a plurality of answers. For example, in the example of FIG. 5, the answer 14 includes a first answer 16 and a second answer 18.

The first answer 16 indicates the completeness of security countermeasures by rank. The ranks in this example are represented by 1 to 4. Ranks 1 to 4 represent “1: sufficiently implemented”, “2: implemented to some extent”, “3: not implemented much”, and “4: not implemented at all”.

The second answer 18 indicates a specific implementation content of the security countermeasure in sentences. If no security countermeasures have been taken, the second answer 18 may be blank.

The method of configuring the answer 14 is not limited to the above-described method. For example, the answer 14 may indicate only one of a completeness of security countermeasures and specific contents of implemented security countermeasures. In addition, for example, the answer 14 may indicate whether the security countermeasure has been implemented instead of the completeness of the security countermeasure.

As described above, the question regarding the implementation status of the security countermeasure may be classified into a plurality of categories. Therefore, the answers indicated in the answer information 10 may be classified into a plurality of categories. For example, the answer information 10 includes a table for each category. In addition, for example, the answer information 10 may further include a column indicating an identifier of a category. That is, the answer information 10 may indicate the category of the question, the content of the question, and the content of the answer in association with each other for each question.

The answer information 10 may not indicate the question 12. For example, question information in which questions are listed is used separately from the answer information 10. In this case, the answer information 10 and the question information are configured such that it is possible to know to which question indicated in the question information each answer indicated in the answer information 10 is an answer. For example, the answer information 10 and the question information are configured such that the rank of the question indicated in the question information and the rank of the answer to the question indicated in the answer information 10 coincide with each other. That is, the answer to the i-th question in the question information is indicated as the i-th question in the answer information 10. In a case where the question is classified into a plurality of categories, the question information may further indicate a category of each question.

The question information may be input to the audit model 100 together with the answer information 10, or may be given in advance into the audit model 100 as prior knowledge.

### <Regarding Creation of Question>

The question made to the target entity may be manually created or automatically created using a computer. In the latter case, for example, the question is self-created using a language model. The language model used to create the question may be the audit model 100 or a language model other than the audit model 100.

For example, the question can be created based on a standard of security countermeasures. In a case where the standard is used, for example, a prompt such as “Please create 30 questions regarding the implementation status of security countermeasures using the standard to be input.” is input into the language model. As a result, a predetermined number of questions regarding the implementation status of the security countermeasure can be created based on the standard. As a standard of security countermeasures, an international standard, a national standard, a standard defined by an arbitrary organization, or the like can be used.

At least one question may be created for each of the plurality of categories indicated in the standard. Therefore, for example, it may include an instruction such as “Please ensure that at least one question is created for each category indicated in the standard.” in a prompt to create a question.

### <Concerning Audit Model 100>

The audit model 100 is a language model that performs an operation of “in response to input of a sentence (prompt) indicating an instruction, execute processing according to the instruction, and output data indicating an execution result of the processing”. In addition to prompts, the audit model 100 may further be input with additional information (hereinafter, additional information) used for processing in accordance with the instructions indicated in the prompt.

In a case of being utilized by the security audit apparatus 2000, the prompt input into the audit model 100 is a prompt 20. Answer information 10 is input to the audit model 100 as additional information. The output data output from the audit model 100 is the audit result information 40. Reference information and feature information to be described later can also be input into the audit model 100 as additional information.

The audit model 100 includes a machine learning model such as a neural network. For example, the audit model 100 is a language model classified into a large language model (LLM).

The audit model 100 may be a general-purpose language model, or may be a language model trained for security audit. In the latter case, for example, the audit model 100 is generated by training the general-purpose language model using a plurality of combinations of input data for causing the security audit to be performed and the ground-truth data relevant to the input data. The input data for causing the security audit to be performed includes a combination of the prompt 20 and the answer information 10. The input data may further include reference information and feature information to be described later. The ground-truth data is ideal output data.

### <Generation of Audit Result Information 40: S104>

The generation unit 2040 generates the audit result information 40 by inputting the answer information 10 into the audit model 100 (S104). Hereinafter, the security audit using the audit model 100 will be described in detail.

### <<Regarding Prompt 20>>

The generation unit 2040 inputs a prompt 20 to the audit model 100 to cause the audit model 100 to implement the security audit. The prompt 20 is a text indicating instructions for causing the audit model 100 to perform a security audit, as described above. As an instruction for executing the security audit, for example, an instruction such as “Perform security audit using input files.” can be considered.

The text included in the prompt 20 is not limited only to the instruction for causing the security audit to be performed. For example, the prompt 20 includes a description related to the answer information 10. The explanation related to the answer information 10 includes, for example, explanation related to the configuration of the answer information 10, such as explanation of the meaning of the data indicated in each column of the answer information 10. The configuration of the answer information 10 will be described below, for example.
The first column shows questions regarding security countermeasures.
The second column shows the completeness of implementation of the security countermeasures asked.
The completeness is represented by ranks 1 to 4.
Ranks 1 to 4 represent “1: fully implemented”, “2: somewhat implemented”, “3: not implemented much”, and “4: not implemented at all”.
The third column shows the specific implementation contents of the security countermeasures asked.

In addition, for example, the prompt 20 includes descriptions about files that are input into the audit model 100. For example, it is assumed that a file abc.csv including the answer information 10 is used. In this case, the prompt 20 includes an explanatory sentence such as “Abc.csv is a file that shows answers to questions regarding security countermeasures”.

Additionally, for example, the prompt 20 indicates a role for the audit model 100. Specifically, by including text such as “You are an auditor who conducts security audits.” in the prompt 20, the audit model 100 can be given a virtual role as an auditor to perform a security audit.

Among the information that can be included in the prompt 20 described above, there is information common (in other words, it does not rely on individual security audits) in the security audit using the audit model 100. For example, description regarding the configuration of the answer information 10, assignment of roles to the audit model 100, and the like do not depend on individual security audits. In this manner, information that does not rely on an individual security audit may not be included in the prompt 20 and may be given in advance to the audit model 100 as prior knowledge.

### <<Use of Reference Information>>

For example, the generation unit 2040 causes the audit model 100 to execute the security audit by comparing the answer information 10 with information (hereinafter, reference information) indicating a reference regarding implementation of the security countermeasure. In this case, the acquisition unit 2020 may further acquire the reference information in addition to the answer information 10. The method of acquiring the reference information is similar to the method of acquiring the answer information 10.

As the reference information, for example, information indicating a standard of security countermeasures can be used. As described above, as the standard of security countermeasures, an international standard, a national standard, a standard defined by an arbitrary organization, or the like can be used. By performing the security audit using a predetermined standard such as an international standard or a national standard, it is possible to easily grasp a problem or the like seen from the predetermined standard with respect to the security countermeasure implemented by the target entity.

In addition, for example, information indicating a model answer for each question can be used as the reference information. As the information indicating the model answer, for example, answer information created by a representative entity can be used. The representative entity is, for example, a parent company of the target entity, a security expert, or the like. By performing the security audit based on the model answer in this manner, it is possible to easily grasp a deviation of the security countermeasure performed by the target entity from the exemplary security countermeasure.

For example, in a company group, a subsidiary company may be required to implement a security countermeasure that follows the security countermeasure implemented by the parent company. In such a situation, the audit of the security countermeasures implemented by the subsidiary may be performed using the answer of the model created by the parent company as the reference information. With such a security audit, it is possible to easily grasp how close the security countermeasure implemented by the subsidiary company is to the security countermeasure implemented by the parent company.

For example, the security audit apparatus 2000 inputs the reference information together with the answer information 10 to the audit model 100. In this case, the prompt 20 may include description related to the reference information and the answer information 10. For example, it is assumed that a file abc.csv is input as the answer information 10 and a file def.csv is input as the reference information. In this case, for example, the following prompt 20 may be utilized.
abc.csv indicates answers to questions regarding security countermeasures.
def.csv indicates the reference for implementing security countermeasures.
Please compare the response to the reference and perform the security audit.

The reference information may be given to the audit model 100 in advance as prior knowledge. In this case, in a case of inputting the answer information 10 to the audit model 100, the generation unit 2040 does not need to input the reference information.

### <<Regarding Audit Result Information 40>>

The audit result information 40 indicates a result of the security audit on the target entity. The results of the security audit indicated in the audit result information 40 vary. For example, the audit result information 40 indicates an overall evaluation of the security countermeasures implemented by the target entity. In addition, for example, the audit result information 40 indicates weak points and strong points of the target entity from the viewpoint of security countermeasures. In addition, for example, the audit result information 40 indicates a countermeasure recommended for the target entity (improvement countermeasure for security countermeasure).

There are various possible overall evaluations of the target entity. For example, the audit result information 40 indicates a summary of differences between the answer information 10 and the reference information as an overall evaluation. In addition, for example, the audit result information 40 indicates the degree of implementation of the security countermeasure by the target entity as the overall evaluation. The degree of implementation of the security countermeasure is represented by, for example, a ratio of the number of implemented security countermeasures to the number of required security countermeasures. In addition, for example, the degree to which the security countermeasure has been implemented may be represented by a rank such as “almost implemented”, “somewhat implemented”, “less implemented”, or “almost not implemented”.

Various weak points can be considered as the target entity. For example, the audit result information 40 indicates, as a weak point, a security countermeasure that is not implemented by the target entity. In addition, for example, the audit result information 40 indicates, as a weak point, a security countermeasure having a low completeness among the security countermeasures implemented by the target entity. In addition, for example, the audit result information 40 indicates, as a weak point, a difference between the specific content of the security countermeasure executed by the target entity and the content indicated in the reference information.

Various strong points can be considered as the target entity. For example, the audit result information 40 indicates, as strong points, security countermeasures being implemented by the target entity. In addition, for example, the audit result information 40 indicates, as a strong point, a security countermeasure having a high completeness among the security countermeasures implemented by the target entity. In addition, for example, the audit result information 40 indicates, as a strong point, a matching point between the specific content of the security countermeasure executed by the target entity and the content indicated in the reference information.

The audit result information 40 may indicate a category of the security countermeasure for the weak point or the strong point. That is, the audit result information 40 may indicate which category is a weak point of the target entity (which category of security countermeasures is insufficient) and which category is a strong point of the target entity (which category of security countermeasures is sufficient) among a plurality of categories of security countermeasures.

Various improvement countermeasures for security countermeasures can be considered. For example, the audit result information 40 indicates an improvement countermeasure for implementing a security countermeasure that has not been implemented by the target entity. In addition, for example, the audit result information 40 indicates an improvement countermeasure for increasing the completeness of security countermeasures with a low completeness among the security countermeasures implemented by the target entity. In addition, for example, the audit result information 40 indicates, as an improvement countermeasure, the content indicated in the reference information for the security countermeasure whose specific content is different from the content indicated in the reference information among the security countermeasures executed by the target entity.

What kind of information should be specifically specified as the overall evaluation, weak point, strong point, and improvement countermeasure of the target entity in this manner may be given to the audit model 100 in advance as prior knowledge.

It may designate the type of information to be included in the audit result information 40 for the audit model 100. The type of information to be included in the audit result information 40 can be specified in the prompt 20, for example. For example, the prompt 20 including designation such as “Please include overall evaluation, weak points, and recommended countermeasures in audit results to be output.” is utilized.

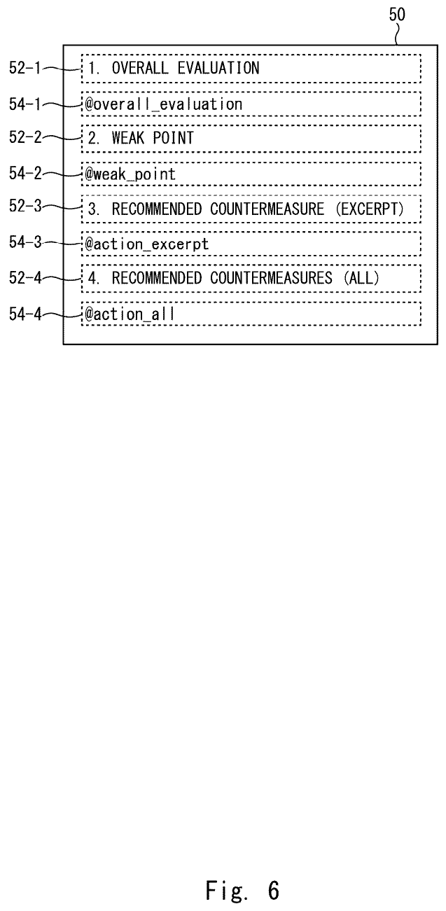

The type of information to be included in the audit result information 40 may be designated using information indicating a template of the audit result information 40 (hereinafter, the template information). FIG. 6 is a diagram illustrating template information. Template information 50 includes a plurality of pairs of an item name 52 and a content 54. The item name 52 indicates the name of the item. The content 54 indicates a character string to be replaced with the actual content of the item.

For example, an item name 52-1 indicates the name of an item “1. Overall evaluation”. Then, a content 54-1 relevant to the item name 52-1 indicates “@overall_evaluation” as a mark to be replaced with the text indicating the overall evaluation. The audit model 100 generates text indicating the overall evaluation and replaces @overall_evaluation with the generated text.

The audit model 100 can grasp what kind of information should be generated by the security audit by performing the security audit with reference to the template information 50. For example, by referring to the template information 50 in FIG. 6, the audit model 100 can grasp that 1) it is necessary to perform overall evaluation on the security countermeasures of the target entity, 2) it is necessary to specify weak points of the target entity, and 3) it is necessary to extract particularly important countermeasures from among all recommended countermeasures after specifying all the recommended countermeasures. By referring to the template information 50, the audit model 100 can generate the audit result information 40 in a predetermined format. From the above, by using the template information 50, information necessary for the user can be provided to the user who uses the audit result in a format that is easy for the user to use.

The configuration of the audit result information 40 may be given to the audit model 100 in advance as prior knowledge.

### <<Use of Feature Information>>

In the security audit using the audit model 100, in addition to the answer information 10, information indicating the features of the target entity (hereinafter, feature information) may be further used. The feature information indicates, for example, an answer by the target entity to a question regarding the feature of the target entity. The feature information can also be expressed as profile information or the like.

In a case where the feature information is used, the acquisition unit 2020 acquires the feature information in addition to the answer information 10. The method of acquiring the feature information is similar to the method of acquiring the answer information 10.

The answer information 10 and the feature information may be collected in one file (hereinafter, an answer file) representing an answer to a question. In this case, an answer file indicating both an answer to the question regarding the implementation status of the security countermeasure and an answer to the question regarding the feature of the target entity is input to the audit model 100.

In a case where the feature information is used, the generation unit 2040 inputs the answer information 10, the feature information, and the prompt 20 into the audit model 100. In this case, it may include a text instructing to perform the security audit based on the answer information 10 and the feature information in the prompt 20. For example, the prompt 20 includes the text “Please perform security audit using answer information and feature information.”.

As described above, the question relevant to the answer may be included in the answer information 10 or may be indicated in question information different from the answer information 10. Similarly, the question about the feature of the target entity may be included in the feature information, or may be indicated in information (hereinafter, second question information) different from the feature information. The question information and the second question information may be put together in one file (hereinafter, a question file) representing a question. In this case, a question file indicating both a question regarding the implementation status of the security countermeasure and a question regarding the feature of the target entity is input to the audit model 100.

Various features can be handled as features of the target entity. For example, the feature of the target entity is a name of the target entity, a scale of the target entity (hereinafter, entity scale), a type of business related to the target entity (hereinafter, business type), an acquisition status of various authentications by the target entity (hereinafter, authentication acquisition status), a type of information handled by the target entity (hereinafter, information type), or the like.

The entity scale is represented by, for example, the number of affiliated persons, the number of group companies, the number of affiliated persons of a group company, the number of contractor companies, the number of contractor workers, sales, or profit. The number of affiliated persons represents the number of persons (the number of employees belonging to the company, the number of members belonging to the department, the number of members belonging to the project team, or the like) belonging to the target entity. The number of group companies represents, for a company group including the target entity, the number of companies (hereinafter, group companies) belonging to the company group. The number of affiliated persons of the group company represents the total number of affiliated persons of each group company. The number of contractor companies represents the number of external companies to which the target entity entrusts business. The number of contractor workers represents the total number of persons involved in the entrusted business in the external company that entrusts the business. The sales and the profit represent the sales and the profit of the target entity. For example, the sales and the profit are represented by numerical values for the most recent one year.

The business type is represented by, for example, the type of business performed by the target entity itself, the type of business performed by a company that is a business partner of the target entity, or the like. For example, the feature information indicates one or more of a plurality of predetermined types of business as the business type. The predetermined type of business may include a defense business, a space business, an infrastructure business, an automobile business, a home appliance business, or the like.

The business type is not limited to the type of business already involved with the target entity. The business type may include a type of business that the target entity is going to be involved in, or a type of business that the target entity is expected to be involved in the future.

The authentication acquisition status is represented by, for example, the type of authentication acquired by the target entity among a plurality of predetermined types of authentication related to security.

The information type is represented by, for example, a type of information for which security countermeasures are important among the information handled by the target entity. The information on which the security countermeasure is important is information having a large influence in a case where the information is leaked.

For example, the feature information indicates, as an information type, a type of information handled by the target entity among a plurality of predetermined types. The predetermined type of information may include types such as personal information (such as address and personal number), company confidential information, group confidential information, information related to defense business, information related to space business, or information related to infrastructure.

The information type is not limited to the type of information already handled by the target entity. The information type may include a type of information that the target entity is going to handle or a type of information that the target entity is expected to handle in the future.

By providing the feature information to the audit model 100, it is possible to cause the audit model 100 to perform the security audit in consideration of the feature of the target entity.

For example, the name of the target entity may be related to the magnitude of the influence of the occurrence of the security problem on the corporate image. For example, it is assumed that the name of the target entity includes the name or abbreviation of the parent company. In this case, in a case where a security problem occurs in the target entity, not only the corporate image of the target entity but also the corporate image of the parent company may greatly deteriorate. The same applies to a case where the name of the target entity includes the name or abbreviation of the company group.

Therefore, for example, in a case where the name of the target entity includes the name or abbreviation of the parent company or the company group, the audit model 100 performs the security audit under a stricter condition as compared with other cases.

The scale of the target entity may affect an assumed risk, an implementable countermeasure, the magnitude of the influence of incident occurrence, or the like. For example, since the risk of information leakage and the like increases in a case where there are many people involved in business, the risk of information leakage and the like is high for companies with many employees and companies with many contractors. There is a high probability that a small company has few people who are familiar with security, and thus it is difficult for a small company to take detailed countermeasures. Further, a listed company is considered to have a greater loss of confidence upon incident occurrence than an unlisted company.

The business type of the target entity may affect the assumed risk, the magnitude of the influence due to the incident occurrence, and the like. For example, it is considered that a business type dealing with national defense is likely to be targeted by an attacker, and the damage at the time of incident is also large.

The authentication acquisition status is useful for grasping an acquisition status related to security of the target entity. For example, in a case where the target entity has acquired ISMS (**) authentication, the target entity can be regarded to have implemented more than a certain level of countermeasures required by ISMS regulations within the acquisition range.

The type of information handled by the target entity can affect the magnitude of the influence of incident occurrence and the appropriate way of handling information depending on the information to be handled. For example, in a case where the target entity handles personal information such as an individual number (Social Security Number), if an incident occurs and information is leaked, it becomes a major problem. Therefore, the target entity is required to handle information more strictly.

The security audit apparatus 2000 may cause the audit model 100 to identify a security risk derived from the feature information. In this case, the audit result information 40 further includes a security risk derived from the feature information. Examples of the security risk derived from the feature information include “If there are many contractors, there is a risk of supply chain management” and “Since the individual number collecting operation is performed, there is a risk that the damage will increase at the time of information leakage”.

In order to include the security risk derived from the feature information in the audit result information 40, for example, an item such as “The security risk derived from the feature information” is included as one of items indicated in the template information 50. By using the template information 50 for the audit model 100, it is possible to cause the audit model 100 to identify a security risk derived from the feature information.

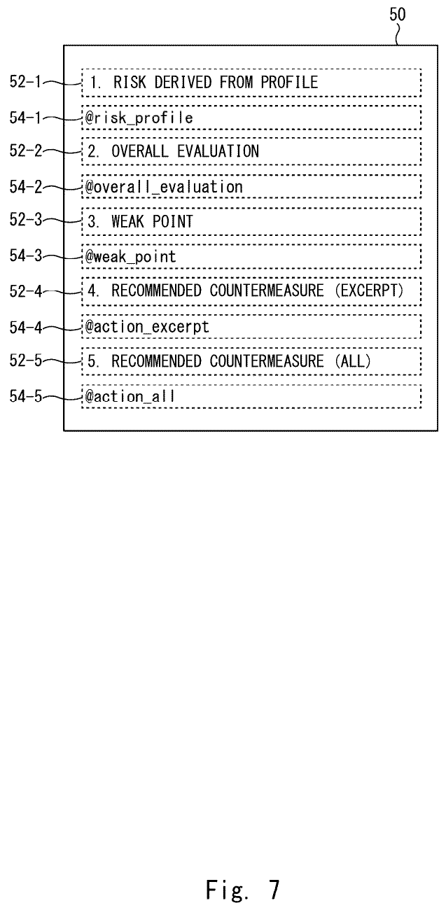

FIG. 7 is a second diagram illustrating the template information 50. The template information 50 of FIG. 7 indicates “risk derived from profile” as the first item. The profile mentioned here means a feature of the target entity. Therefore, by using the template information 50 illustrated in FIG. 7 for the audit model 100, the audit result information 40 includes a security risk derived from the feature information.

The audit result information 40 generated using the template information 50 of FIG. 7 indicates, for example, the following contents. However, in the following example, “5. Recommended countermeasures (all)” is omitted.

1. Risk Derived from Profile

Protection of customer information handled by cloud services is important for the security risk of company A. From the acquisition of the authentication C1 and the authentication C2, it can be seen that the company is working on information protection, but since the final delivery destination is an important infrastructure, information leakage is a major risk. From the viewpoint of the number of employees, the number of employees of the group company, and the number of workers of the contractor, human errors are also a non-negligible risk.

### 2. Overall Evaluation

Company A has implemented security countermeasures as a whole, but some of them are insufficient.

### 3. Weak Point

More countermeasures are necessary particularly for the information management category.

### 4. Recommended Countermeasure (Excerpt)

For Q2-4 “Do you encrypt information with a high level of confidentiality that would impact business if leaked?”, it is important to apply an appropriate encryption technology to highly confidential information to minimize the risk of unauthorized access and information leakage. With reference to the countermeasures of the parent company and the international standard S1, perform encryption at the time of data storage and communication to enhance information security.

In the above-described specific example, Q2-4 represents a question number.

### <<Processing of Audit Result Information 40>>

The generation unit 2040 may perform arbitrary processing on the audit result information 40 output from the audit model 100. For example, the audit result information 40 output from the audit model 100 indicates an evaluation score indicating the degree of evaluation of the security countermeasure by the target entity, not a sentence, as information indicating the overall evaluation of the target entity. The evaluation score is represented by, for example, a weighted sum of values indicating the completeness of security countermeasures.

In a case where the evaluation score is included in the audit result information 40, the prompt 20 may include an instruction to calculate the evaluation score. For example, the prompt 20 includes an indication such as “Please include in the audit results an evaluation score indicating the degree of evaluation of security countermeasures”.

The generation unit 2040 generates an evaluation text that is a text indicating the overall evaluation of the target entity by using the evaluation score and adds the evaluation text to the audit result information 40. For example, a plurality of association between the numerical range of the evaluation score and the evaluation text is determined in advance. Specifically, correspondences such as “x1 or more: countermeasures can be taken as a whole”, “x2 or more and less than x1: countermeasures can be taken almost all”, “x3 or more and less than x2: countermeasures cannot be taken much”, and “less than x3: countermeasures cannot be taken at all” are defined.

The generation unit 2040 specifies a numerical range in which the evaluation score indicated in the audit result information 40 output from the audit model 100 is included among a plurality of predetermined numerical ranges. Then, the generation unit 2040 adds the evaluation text relevant to the specified numerical range to the audit result information 40.

Here, the weight of each answer used for calculation of the evaluation score may be fixed in advance or may be dynamically determined. In the latter case, for example, the weight of each answer is determined using the feature information. In this case, the prompt 20 may include text indicating weighting based on the feature, such as “Please decide the weight given to each answer based on the feature indicated in the feature information”.

The evaluation score may be calculated for each category of the security countermeasure. In this case, the generation unit 2040 specifies the evaluation text for each category.

The above-described processing of “Evaluation text is identified from evaluation score, and evaluation text is included in audit result information 40” may be performed inside the audit model 100.

The evaluation score for each category can also be used to specify strong points and weak points. For example, it is assumed that the audit result information 40 output from the audit model 100 indicates the evaluation score for each category but does not indicate the strong point and the weak point. In this case, the generation unit 2040 specifies weak points and strong points using the evaluation score for each category indicated in the audit result information 40. For example, the generation unit 2040 specifies a category having the maximum evaluation score as a strong point. On the other hand, the generation unit 2040 specifies a category having the minimum evaluation score as a weak point. Then, the generation unit 2040 adds the strong point category and the weak point category to the audit result information 40.

The recommended countermeasures may be excerpted outside of the audit model 100. For example, the audit model 100 includes all recommended countermeasures in the audit result information 40 in association with their importance level. The generation unit 2040 extracts the recommended countermeasure indicated in the audit result information 40 based on the importance level. Then, the generation unit 2040 adds an excerpt item (third item in the example of FIG. 6) indicating the extracted recommended countermeasure to the audit result information 40.

The prompt 20 may include an instruction to calculate the importance level of each recommended countermeasure. For example, the prompt 20 includes an indication “Please include recommended countermeasures together with their importance levels in the results of the security audit.”.

There are various methods for extracting the recommended countermeasure based on the importance level. For example, the generation unit 2040 extracts top N recommended countermeasures in order of importance levels. In addition, for example, the generation unit 2040 extracts a recommended countermeasure whose importance level is equal to or higher than a threshold.

### <Output of Audit Result Information 40>

The security audit apparatus 2000 outputs the audit result information 40 by various methods. For example, the security audit apparatus 2000 stores the audit result information 40 in an arbitrary storage unit. In addition, for example, the security audit apparatus 2000 outputs the audit result information 40 to a display device or the like to display the audit result information 40 on the display device or the like. In addition, for example, the security audit apparatus 2000 transmits the audit result information 40 to another device. For example, as described above, it is assumed that the user of the security audit apparatus 2000 uses the security audit apparatus 2000 from the user terminal via the web system. In this case, the security audit apparatus 2000 transmits the audit result information 40 to the user terminal.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for explaining illustrative example embodiments are not necessarily mandatory, and some features or steps may be omitted. The order of the steps described in any of the drawings may be changed as appropriate.

The program includes a group of instructions (or software code) for causing the computer to perform one or more functions described in the example embodiments in a case where the program is loaded into the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communications medium. As an example and not by way of limitation, a transitory computer-readable or communication medium includes electrical, optical, acoustic, or other forms of propagated signals.

Some or all of the above-described example embodiments may be described as the following supplementary notes, but are not limited to the following supplementary notes.

### Supplementary Note 1

A security audit apparatus including:
an acquisition means for acquiring answer information indicating an answer by a target entity to a question regarding implementation of a security countermeasure; and
a generation means for generating audit result information indicating a result of an audit on the implementation of the security countermeasure by the target entity by inputting a prompt for instructing to perform an audit on the implementation of the security countermeasure based on the answer information and the answer information into a language model.

### Supplementary Note 2

The security audit apparatus according to Supplementary Note 1, in which
the acquisition means acquires reference information indicating a standard for implementation of a security countermeasure, and
the generation means generates the audit result information by inputting, into the language model, the reference information, the answer information, and the prompt for instructing to perform the audit by comparing the answer information with the reference information.

### Supplementary Note 3

The security audit apparatus according to Supplementary Note 1, in which
the acquisition means acquires reference information indicating an answer of a model to the question, and
the generation means generates the audit result information by inputting, into the language model, the reference information, the answer information, and the prompt for instructing to perform the audit by comparing the answer information with the reference information.

### Supplementary Note 4

The security audit apparatus according to Supplementary Note 1, in which the answer information indicates, for each of a plurality of the questions regarding the security countermeasure, a completeness of implementation of the security countermeasure and a specific implementation content of the security countermeasure.

### Supplementary Note 5

The security audit apparatus according to Supplementary Note 4, in which
the prompt includes an instruction to calculate an evaluation value indicating a degree of evaluation of the security countermeasure performed by the target entity, and
the generation means specifies a text of the evaluation relevant to the evaluation value calculated by the language model from a text of evaluation defined in association with each of a plurality of numerical ranges of the evaluation value, and generates the audit result information including the specified text of the evaluation.

### Supplementary Note 6

The security audit apparatus according to Supplementary Note 1, in which
the prompt includes an instruction for specifying a weak point for a security countermeasure, a strong point for a security countermeasure, or both of the points for the target entity, and
the audit result information indicates the weak point, the strong point, or both of the points.

### Supplementary Note 7

The security audit apparatus according to Supplementary Note 1, in which
the prompt includes an instruction for causing the target entity to identify a recommended improvement countermeasure for a security countermeasure, and
the audit result information indicates the improvement countermeasure.

### Supplementary Note 8

The security audit apparatus according to Supplementary Note 1, in which
the acquisition means acquires feature information indicating a feature of the target entity, and
the generation means generates the audit result information by inputting the answer information, the feature information, and a prompt instructing to perform the audit based on the answer information and the feature information into a language model.

### Supplementary Note 9

The security audit apparatus according to Supplementary Note 8, in which the feature information indicates a name of the target entity.

### Supplementary Note 10

The security audit apparatus according to Supplementary Note 8, in which the feature information indicates a type of information handled by the target entity.

### Supplementary Note 11

The security audit apparatus according to Supplementary Note 8, in which the feature information indicates a size of a scale of the target entity.

### Supplementary Note 12

The security audit apparatus according to Supplementary Note 8, in which the feature information indicates a type of business related to the target entity.

### Supplementary Note 13

The security audit apparatus according to Supplementary Note 1, in which the question is a question regarding information security governance, a question regarding information management, a question regarding a countermeasure against an information security threat, a question regarding detection of the threat, a question regarding a countermeasure against the detected threat, a question regarding recovery after the countermeasure, or a question regarding training of human resources dealing with information security.

### Supplementary Note 14

A security audit method including:
acquiring answer information indicating an answer by a target entity to a question regarding implementation of a security countermeasure; and
generating audit result information indicating a result of an audit on the implementation of the security countermeasure by the target entity by inputting a prompt for instructing to perform an audit on the implementation of the security countermeasure based on the answer information and the answer information into a language model.

### Supplementary Note 15

A program for causing a computer to execute:
acquiring answer information indicating an answer by a target entity to a question regarding implementation of a security countermeasure; and
generating audit result information indicating a result of an audit on the implementation of the security countermeasure by the target entity by inputting a prompt for instructing to perform an audit on the implementation of the security countermeasure based on the answer information and the answer information into a language model.

Some or all of the elements (for example, configurations and functions) described in Supplementary Notes 2 to 13 dependent on Supplementary Note 1 can also be dependent on Supplementary Notes 14 and 15 by the same dependency relationship as Supplementary Notes 2 to 13. Some or all of the elements described in any Supplementary Note may be applied to various types of hardware components, software components, recording means for recording software components, systems, and methods.

1. A security audit apparatus comprising:
at least one memory that is configured to store instructions; and
at least one processor that is configured to execute the instructions to:
acquire answer information indicating an answer by a target entity to a question regarding implementation of a security countermeasure; and
generate audit result information indicating a result of an audit on the implementation of the security countermeasure by the target entity by inputting a prompt for instructing to perform an audit on the implementation of the security countermeasure based on the answer information and the answer information into a language model.

2. The security audit apparatus according to claim 1,
wherein the at least one processor is configured further to acquire reference information indicating a standard for implementation of a security countermeasure, and
wherein the generation of the audit result information includes inputting, into the language model, the reference information, the answer information, and the prompt for instructing to perform the audit by comparing the answer information with the reference information.

3. The security audit apparatus according to claim 1,
wherein the at least one processor is configured further to acquire reference information indicating an answer of a model to the question, and
wherein the generation of the audit result information includes inputting, into the language model, the reference information, the answer information, and the prompt for instructing to perform the audit by comparing the answer information with the reference information.

4. The security audit apparatus according to claim 1, wherein the answer information indicates, for each of a plurality of the questions regarding the security countermeasure, a completeness of implementation of the security countermeasure and a specific implementation content of the security countermeasure.

5. The security audit apparatus according to claim 4,
wherein the prompt includes an instruction to calculate an evaluation value indicating a degree of evaluation of the security countermeasure performed by the target entity, and
wherein the generation of the audit result information includes: specifying a text of the evaluation relevant to the evaluation value calculated by the language model from a text of evaluation defined in association with each of a plurality of numerical ranges of the evaluation value; and generating the audit result information including the specified text of the evaluation.

6. The security audit apparatus according to claim 1,
wherein the prompt includes an instruction for specifying a weak point for a security countermeasure, a strong point for a security countermeasure, or both of the points for the target entity, and
wherein the audit result information indicates the weak point, the strong point, or both of the points.

7. The security audit apparatus according to claim 1,
wherein the prompt includes an instruction for causing the target entity to identify a recommended improvement countermeasure for a security countermeasure, and
wherein the audit result information indicates the improvement countermeasure.

8. The security audit apparatus according to claim 1,
wherein the at least one processor is configured further to acquire feature information indicating a feature of the target entity, and
wherein the generation of the audit result information includes inputting the answer information, the feature information, and a prompt instructing to perform the audit based on the answer information and the feature information into a language model.

9. The security audit apparatus according to claim 8, wherein the feature information indicates a name of the target entity.

10. The security audit apparatus according to claim 8, wherein the feature information indicates a type of information handled by the target entity.

11. The security audit apparatus according to claim 8, wherein the feature information indicates a size of a scale of the target entity.

12. The security audit apparatus according to claim 8, wherein the feature information indicates a type of business related to the target entity.

13. The security audit apparatus according to claim 1, wherein the question is a question regarding information security governance, a question regarding information management, a question regarding a countermeasure against an information security threat, a question regarding detection of the threat, a question regarding a countermeasure against the detected threat, a question regarding recovery after the countermeasure, or a question regarding training of human resources dealing with information security.

14. A security audit method, performed by one or more computers, comprising:
acquiring answer information indicating an answer by a target entity to a question regarding implementation of a security countermeasure; and
generating audit result information indicating a result of an audit on the implementation of the security countermeasure by the target entity by inputting a prompt for instructing to perform an audit on the implementation of the security countermeasure based on the answer information and the answer information into a language model.

15. A non-transitory computer-readable storage medium storing a program for causing one or more computers to execute:
acquiring answer information indicating an answer by a target entity to a question regarding implementation of a security countermeasure; and
generating audit result information indicating a result of an audit on the implementation of the security countermeasure by the target entity by inputting a prompt for instructing to perform an audit on the implementation of the security countermeasure based on the answer information and the answer information into a language model.
